(19) United States
(12) Patent Application Publication
(10) Pub. No.: US 2014/0284194 A1
(43) Pub. Date: Sep. 25, 2014

(54) MEMBRANE SWITCH AND CONNECTION SOCKET

(71) Applicants: DARFON ELECTRONICS CORP., Taoyuan (TW); Darfon Electronics (Suzhou) Co., Ltd., Suzhou (CN)

(72) Inventor: Chao-Lung Chang, Taoyuan (TW)

(73) Assignees: DARFON ELECTRONICS CORP., Taoyuan (TW); Darfon Electronics (Suzhou) Co., Ltd., Suzhou (CN)

(21) Appl. No.: 14/205,249

(22) Filed: Mar. 11, 2014

(30) Foreign Application Priority Data
Mar. 20, 2013 (TW) 102206302

(51) Int. Cl. H01H 13/702; H01R 24/60; H01H 13/12

(52) U.S. Cl. CPC H01H 13/702; H01H 13/12; H01R 24/60
USPC 200/5 A; 200/512; 439/676

(57) ABSTRACT

A membrane switch has two membranes. Each membrane includes a substrate section and a tail section extending from the substrate section. Each membrane has a circuit surface and a back surface opposite to each other. The two substrate sections overlap with the two circuit surfaces facing to each other. One of the two tail sections has a bypass portion at least partially avoiding the projection of the other tail section in the normal direction of the other circuit surface. The distal ends of the two tail sections overlap with the two back surfaces facing to each other.

### BACKGROUND OF THE INVENTION

1. Field of the Invention

The invention relates to a membrane switch and a connection socket applicable to the membrane switch.

2. Description of the Prior Art

A membrane switch is one of major components of keyswitches of a keyboard. In a prior art shown by FIG. 1A, a conventional membrane switch 90 includes a first membrane 10, a second membrane 20, and a separation layer 30. The first membrane 10 includes a first substrate section 11 and a first tail section 12 extending from a side of the first substrate section 11. Therein, the first membrane 10 has a first circuit surface 13 and a first back surface 14 opposite to each other. The second membrane 20 includes a second substrate section 21 and has a second circuit surface 23 and a second back surface 24 opposite to each other. Therein, the first substrate section 11 and the second substrate section 21 overlap with the first circuit surface 13 and the second circuit surface 23 facing to each other. The separation layer 30 is disposed between both and has a plurality of through holes.

First circuitry 15 and second circuitry 25 are disposed on the first circuit surface 13 and the second circuit surface 23 respectively corresponding to the through holes. A plurality of first switches are disposed on the first circuitry 15. A plurality of second switches are disposed on the second circuitry 25. When a specific portion of the membrane switch 90 corresponding to one of the through holes is pressed, the first switch and the second switch corresponding to the specific portion are electrically connected by contacting each other through the through hole corresponding to the specific portion, which is similar to a case of the invention that a first switch 152 and a second switch 252 are electrically connected by contacting each other through a through hole 352, as shown by FIG. 2. Such membrane switch has the first tail section 12 only on the first circuit surface 13. It requires the first tail section 12 to transmit electronic signals over the first circuitry 15 and the second circuitry 25. U.S. patents, U.S. Pat. No. 4,066,851, U.S. Pat. No. 4,561,709, U.S. Pat. No. 4,623,768 and U.S. Pat. No. 4,837,412, belong to such kind of membrane switch of single tail section.

The U.S. patent, U.S. Pat. No. 4,484,039, discloses a different membrane switch having dual tail sections, as shown by FIG. 1B. The membrane switch 2 includes a substrate 4, a membrane 6, a separation layer 8 disposed between the substrate 4 and the membrane 6, and a connection port 26 consisting of a tail section 28 and a tail section 30 extending from the substrate 4 and the membrane 6 respectively. Therein, the tail section 28 and the tail section 30 overlap and extend in parallel. The tails of the tail section 28 and the tail section 30 interlace with each other through slots thereon so that circuit contacts on the opposite surfaces of the substrate 4 and the membrane 6 are located to be back to back after the interlacing of the tails. However, the disposition area of the first circuitry and the disposition area of the second circuitry do not overlap in the direction which the tail sections 28 and 30 overlap. In other words, from a top view, the two areas are disposed separately in different levels. Compared with the conventional membrane switch with single tail section, if the membrane switch 2 is required to have the same quantity of circuit contacts with the same width, the connection port 26 of the membrane switch 2 still needs to be provided with the same width. It is void to the purpose of reducing the size of a connector.

### SUMMARY OF THE INVENTION

An objective of the invention is to provide a membrane switch, which can satisfy the requirement for providing circuit terminals on both sides.

Another objective of the invention is to provide a membrane switch, which can reduce a width of a connection port.

Another objective of the invention is to provide a connection socket, which is used for a membrane switch with circuit terminals on both sides so as to reduce a possibility of shorting.

A membrane switch includes a first membrane and a second membrane. The first membrane includes a first substrate section and a first tail section extending from a side of the first substrate section. Therein, the first membrane has a first circuit surface and a first back surface opposite to the first circuit surface. The second membrane includes a second substrate section and a second tail section extending from a side of the second substrate section. Therein, the second membrane has a second circuit surface and a second back surface opposite to second circuit surface. Therein, the first substrate section and the second substrate section overlap with the first circuit surface facing the second circuit surface. The second tail section has a bypass portion passing through a plane where the first circuit surface is located. Two projections of the bypass portion and the first tail section projected in a normal direction of the first circuit surface are non-overlapped. Two distal ends of the first tail section and the second tail section away from the first substrate section and the second substrate section respectively overlap with the first back surface facing the second back surface.

A membrane switch includes a first membrane and a second membrane. The first membrane has a first circuit surface and a first back surface opposite to the first circuit surface. The first membrane includes a first substrate section, a first tail section and first circuitry. The first tail section extends from a side of the first substrate section and has a first tail section distal end away from the first substrate section. The first circuitry is disposed on the first circuit surface and includes a plurality of first switches and a plurality of first terminals. The first switches are disposed on the first substrate section. The first terminals are disposed on the first tail section distal end. The first terminals are arranged at a first edge. The second membrane has a second circuit surface and a second back surface opposite to the second circuit surface. The second membrane includes a second substrate section, a second tail section, and second circuitry. The second tail section extends from a side of the second substrate section and has a second tail section distal end away from the second substrate section. The second circuitry is disposed on the second circuit surface and includes a plurality of second switches and a plurality of second terminals. The second switches are disposed on the second substrate section. The second terminals are disposed on the second tail section distal end. The second terminals are arranged at a second edge. Therein, the first substrate section and the second substrate section overlap with the first circuit surface facing the second circuit surface. When a user presses one of the first switches, the pressed first switch contacts one of the second switches for being electrically connected. The second tail section has a bypass portion passing through a plane where the first circuit surface is located. Two projections of the bypass portion and the first tail section projected in a normal direction of the first circuit surface are non-overlapped, such that the two distal ends of the first tail section and the second tail section away from the first substrate section and the second substrate section respectively overlap with the first back surface facing the second back surface. The first terminals and the second terminals are exposed out. Therein, the first edge and the second edge are parallel to a direction axis. Projections of the first terminals and the second terminals projected in the normal direction of the first circuit surface are non-overlapped in the direction axis.

A connection socket includes a first inner surface, a second inner surface, a plurality of first inner surface terminals, and a plurality of second inner surface terminals. The first inner surface substantially extends on an X-Y plane. The second inner surface is opposite to the first inner surface. The first inner surface terminals are disposed on the first inner surface. The second inner surface terminals are disposed on the second inner surface. Projections of the first inner surface terminals projected in a Z axis direction and projections of the second inner surface terminals projected in the Z axis direction do not overlap each other. The Z axis direction is substantially perpendicular to the X-Y plane.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A and 1B are schematic diagrams illustrating prior arts.

FIG. 2 is a schematic diagram illustrating a membrane switch of a preferred embodiment according to the invention.

FIG. 3 is a schematic diagram illustrating the display apparatus of another embodiment according to the invention.

FIGS. 4A and 4B are schematic diagrams illustrating a disposition of a first protection layer according to the invention.

FIGS. 5A and 5B are schematic diagrams illustrating a disposition of a second protection layer according to the invention.

FIG. 6 is a sectional view along the section CC′ in FIG. 2.

FIGS. 7A and 7B are schematic diagrams illustrating a connection socket according to the invention.

FIGS. 8A and 8B are schematic diagrams illustrating an embodiment of a membrane switch according to the invention being inserted into and extracted out from the connection socket.

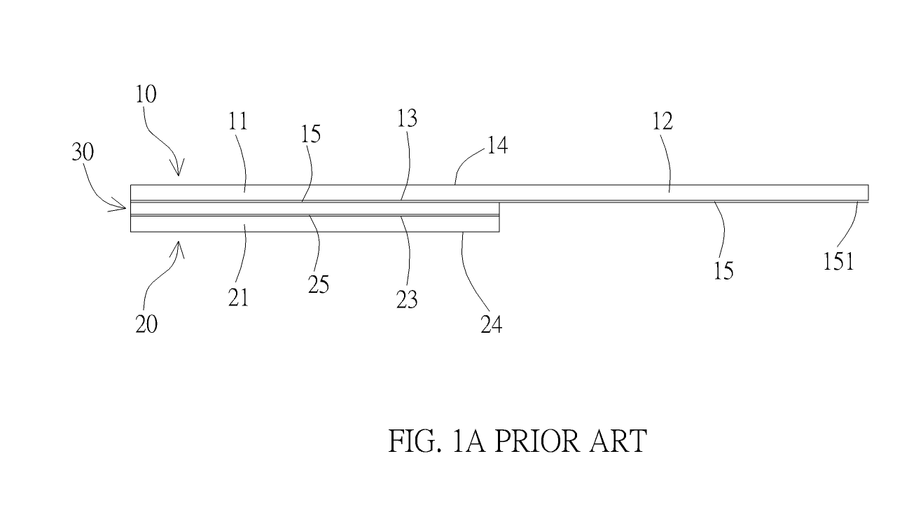

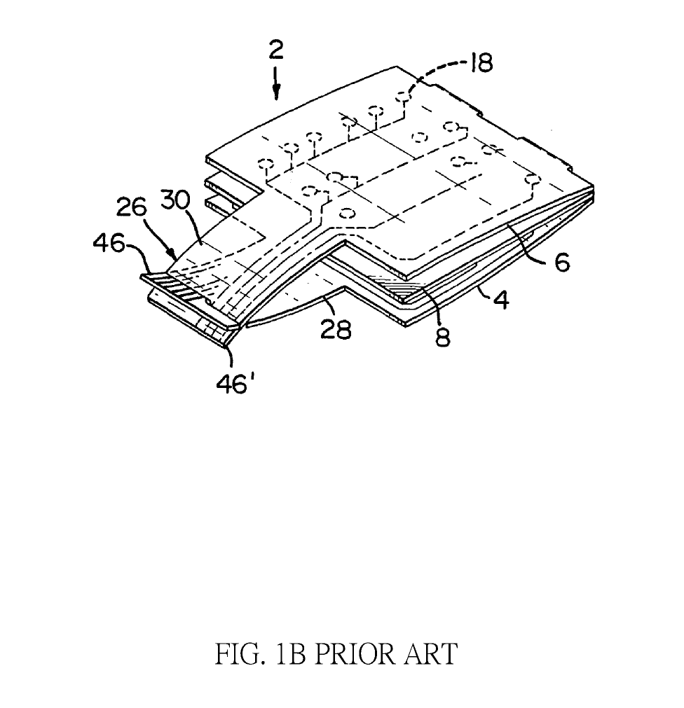

### DETAILED DESCRIPTION

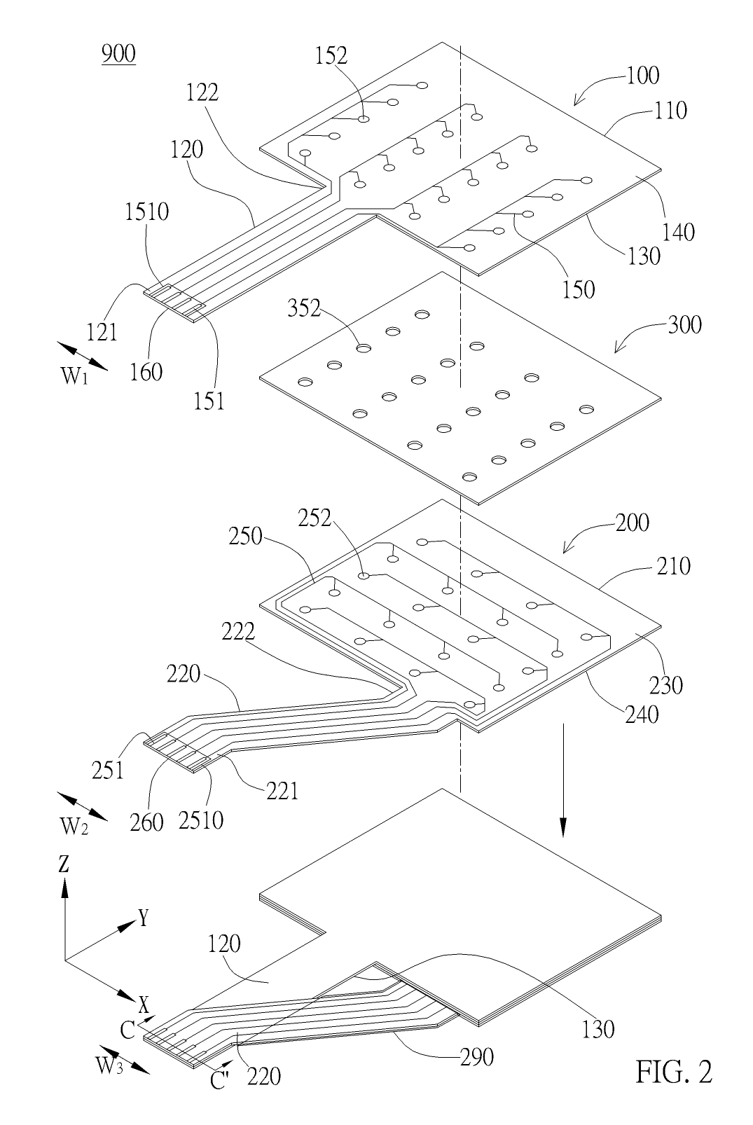

A membrane switch of the invention is preferred for but not limited to a keyboard. As shown by a preferred embodiment in FIG. 2, the membrane switch 900 of the invention includes a first membrane 100 and a second membrane 200. The first membrane 100 includes a first substrate section 110 and a first tail section 120 extending from a side of the first substrate section 110. Therein, the first membrane 100 has a first circuit surface 130 (i.e. a lower surface) and a first back surface 140 (i.e. an upper surface) opposite to the first circuit surface 130. The second membrane 200 includes a second substrate section 210 and a second tail section 220 extending from a side of the second substrate section 210. Therein, the second membrane 200 has a second circuit surface 230 (i.e. a lower surface) and a second back surface 240 (i.e. an upper surface) opposite to second circuit surface 230. Therein, the first substrate section 110 and the second substrate section 210 overlap with the first circuit surface 130 facing the second circuit surface 230. The second tail section 220 has a bypass portion 290 passing through a plane where the first circuit surface 130 is located. Two projections of the bypass portion 290 and the first tail section 120 projected in a normal direction of the first circuit surface 130 are non-overlapped. Two distal ends 121 and 221 of the first tail section 120 and the second tail section 220 away from the first substrate section 110 and the second substrate section 210 respectively overlap with the first back surface 140 facing the second back surface 240.

Specifically, in the preferred embodiment in FIG. 2, the first circuit surface 130 substantially extends on an X-Y plane. The second circuit surface 230 is opposite to the first circuit surface 130. The normal direction of the first circuit surface 130 substantially extends in a Z axis perpendicular to the X-Y plane. The second tail section 220 passes through the plane where the first circuit surface 130 is located by the bypass portion 290 from the outside of the first tail section 120, such that the distal end 121 of the first tail section and the distal end 221 of the second tail section overlap with the first back surface 140 facing the second back surface 240. Thereby, the first tail section 120 of the first membrane 100 and the second tail section 220 of the second membrane 200 can be non-overlapped, achieving that (a) the overlapped portions of the first circuit surface 130 and the second circuit surface 230 at the first substrate section 110 and the second substrate section 210 face each other, and (b) the overlapped portions of the first circuit surface 130 and the second circuit surface 230 at the first tail section distal end 121 and the second tail section distal end 221 are disposed with back to back.

As shown by the preferred embodiment in FIG. 2, the first membrane 100 further includes first circuitry 150 disposed on the first circuit surface 130 and extending from the first substrate section 110 to the first tail section 120. Therein, the first circuitry 150 includes a plurality of first terminals 151 disposed on the distal end 121 of the first tail section 120 away from the first substrate section 110. The second membrane 200 further includes second circuitry 250 disposed on the second circuit surface 230 and extending from the second substrate section 210 to the second tail section 220. Therein, the second circuitry 250 includes a plurality of second terminals 251 disposed on the distal end 221 of the second tail section 220 away from the second substrate section 210. Further, the first circuitry 150 and the second circuitry 250 are distributed over the first circuit surface 130 of the first substrate section 110 and the second circuit surface 230 of the second substrate section 210 respectively, are gathered to the first tail section 120 and the second tail section 220 respectively, and extend to the first tail section distal end 121 and the second tail section distal end 221 respectively.

As shown by the preferred embodiment in FIG. 2, because the first tail section 120 of the first membrane 100 and the second tail section 220 of the second membrane 200 are non-overlapped, the membrane switch 900 of the invention can achieve that the overlapped portions of the first circuit surface 130 and the second circuit surface 230 at the first substrate section 110 and the second substrate section 210 face each other and that the overlapped portions of the first circuit surface 130 and the second circuit surface 230 at the first tail section distal end 121 and the second tail section distal end 221 are disposed with back to back. Therefore, the overlapped portions of the first circuitry 150 and the second circuitry 250 disposed on the first circuit surface 130 and the second circuit surface 230 respectively can face each other at the first substrate section 110 and the second substrate section 210; the overlapped portions of the first circuitry 150 and the second circuitry 250 at the first tail section distal end 121 and the second tail section distal end 221 are disposed with back to back. In the case, the first terminals 151 and the second terminals 251 are disposed on two back-to-back surfaces. Projections of the distribution area 1510 of the first terminals 151 and the distribution area 2510 of the second terminals 251 projected in the normal direction (i.e. the Z axis direction) of the first circuit surface 150 projection overlap. Thereby, the requirement for providing circuit terminals on both sides is satisfied. In another aspect, compared with the U.S. patent (U.S. Pat. No. 4,484,039), the invention needs no the through slots, so the projections of the distribution area 1510 of the first terminals 151 and the distribution area 2510 of the second terminals 251 in the normal direction of the first circuit surface 150 can overlap, so that the width of the connection port (i.e. the overlapped portions of the first tail section distal end 121 and the second tail section distal end 221) of the invention can be reduced.

As shown by the preferred embodiment in FIG. 2, the membrane switch 900 further includes a separation layer 300 disposed between the first substrate section 110 and the second substrate section 210. Specifically, the first circuitry 150 includes a plurality of first switches 152. The second circuitry 250 includes a plurality of second switches 252. The separation layer 300 is used to ensure that the first circuitry 150 and the second circuitry 250 can be disposed with a gap therebetween. The separation layer 300 is provided with a plurality of through holes 352 formed thereon. The first switches 152, the through holes 352, and the second switches 252 are disposed correspondingly in the Z axis direction. Thereby, when a specific portion of the membrane switch 900 is pressed in the Z axis direction, the first switch 152 and the second switch 252 corresponding to the specific portion can contact each other through the through hole 352 for being electrically connected.

As shown by the preferred embodiment in FIG. 2, in another view point, the membrane switch 900 includes the first membrane 100 and the second membrane 200. The first membrane 100 has the first circuit surface 130 and the first back surface 140 opposite to the first circuit surface 130. The first membrane 100 includes the first substrate section 110, the first tail section 120, and the first circuitry 150. The first tail section 120 extends from the side of the first substrate section 110 and has the first tail section distal end 121 away from the first substrate section 110. The first circuitry 150 is disposed on the first circuit surface 130. The first circuitry 150 includes the plurality of the first switches 152 and the plurality of the first terminals 151. The first switches 152 are disposed on the first substrate section 110. The first terminals 151 are disposed on the first tail section distal end 121. The first terminals 151 are arranged on a first edge 160. The second membrane 200 has the second circuit surface 230 and the second back surface 240 opposite to the second circuit surface 230. The second membrane 200 includes the second substrate section 210, the second tail section 220, and the second circuitry 250. The second tail section 220 extends from the side of the second substrate section 210 and has the second tail section distal end 221 away from the second substrate section 210. The second circuitry 250 is disposed on the second circuit surface 230. The second circuitry 250 includes the plurality of the second switches 252 and the plurality of the second terminals 251. The second switches 252 are disposed on the second substrate section 210. The second terminals 251 are disposed on the second tail section distal end 221. The second terminals 251 are arranged on a second edge 260. Therein, the first substrate section 110 and the second substrate section 210 overlap with the first circuit surface 130 facing the second circuit surface 230. When a user presses one of the first switches 152, the pressed first switch 152 contacts one of the second switches 252 for being electrically connected. The second tail section 220 has the bypass portion 290 passing through a plane where the first circuit surface 130 is located. Two projections of the bypass portion 290 and the first tail section 120 projected in a normal direction of the first circuit surface 130 are non-overlapped, such that the first tail section distal end 121 and the second tail section distal end 221 overlap with the first back surface 140 facing the second back surface 240. The first terminals 151 and the second terminals 251 are exposed.

As shown by the preferred embodiment in FIG. 2, the width of the first tail section distal end 121 is W1. The width of the second tail section distal end 221 is W2. The width of the first tail section distal end 121 and the second tail section distal end 221 after overlapping each other is W3. In the preferred embodiment, the first tail section distal end 121 and the second tail section distal end 221 overlap completely in width. The width of the first tail section distal end 121 is equal to the width of the second tail section distal end 221. So W3=W1=W2 herein. However, in different embodiments, it depends on demand for using or manufacturing to let W3<W1+W2; that is, the first tail section distal end and the second tail section distal end overlap only partially. Or let W3 is equal to the larger one of W1 and W2; that is, the first tail section distal end and the second tail section distal end overlap entirely. But the width of the first tail section distal end 121 is different to the width of the second tail section distal end 221.

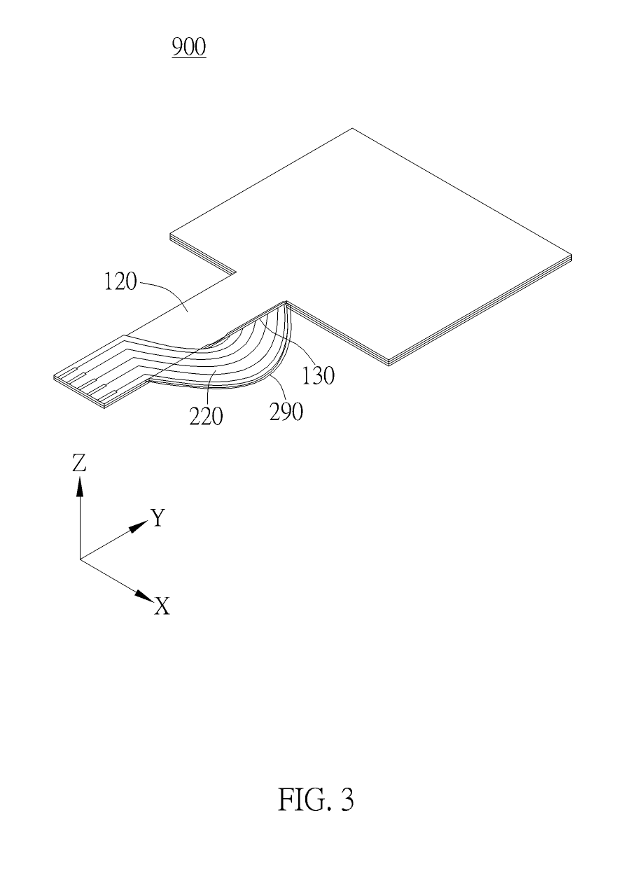

As shown by the preferred embodiment in FIG. 2, two projections of a root 122 of the first tail section 120 and a root 222 of the second tail section 220 projected in the normal direction of the first circuit surface 130 are non-overlapped. However in different embodiments, for meeting the requirement for using or manufacturing, the projections of a root 122 of the first tail section 120 and a root 222 of the second tail section 220 projected in the normal direction of the first circuit surface 130 overlap partially or entirely. For an example shown by FIG. 3, the projections of a root 122 of the first tail section 120 and a root 222 of the second tail section 220 projected in the normal direction of the first circuit surface 130 overlap entirely. In the embodiment, the second tail section 220 is curved further such that the projections of the second tail section 220 and the first tail section 120 projected in the normal direction (i.e. the Z axis direction) of the first circuit surface 130 are non-overlapped at least partially. Similarly, in the embodiment, the second tail section 220 has the bypass portion 290 passing through a plane where the first circuit surface 130 is located. The projections of the bypass portion 290 and the first tail section 120 projected in a normal direction of the first circuit surface 130 are non-overlapped. In other words, the second tail section 220 can be designed in different layouts on the basis of relational position of the root 122 of the first tail section and the root 222 of the second tail section, for meeting the requirement that the projections of the bypass portion 290 and the first tail section 120 projected in a normal direction of the first circuit surface 130 are non-overlapped, and the bypass portion 290 passing through a plane where the first circuit surface 130 is located.

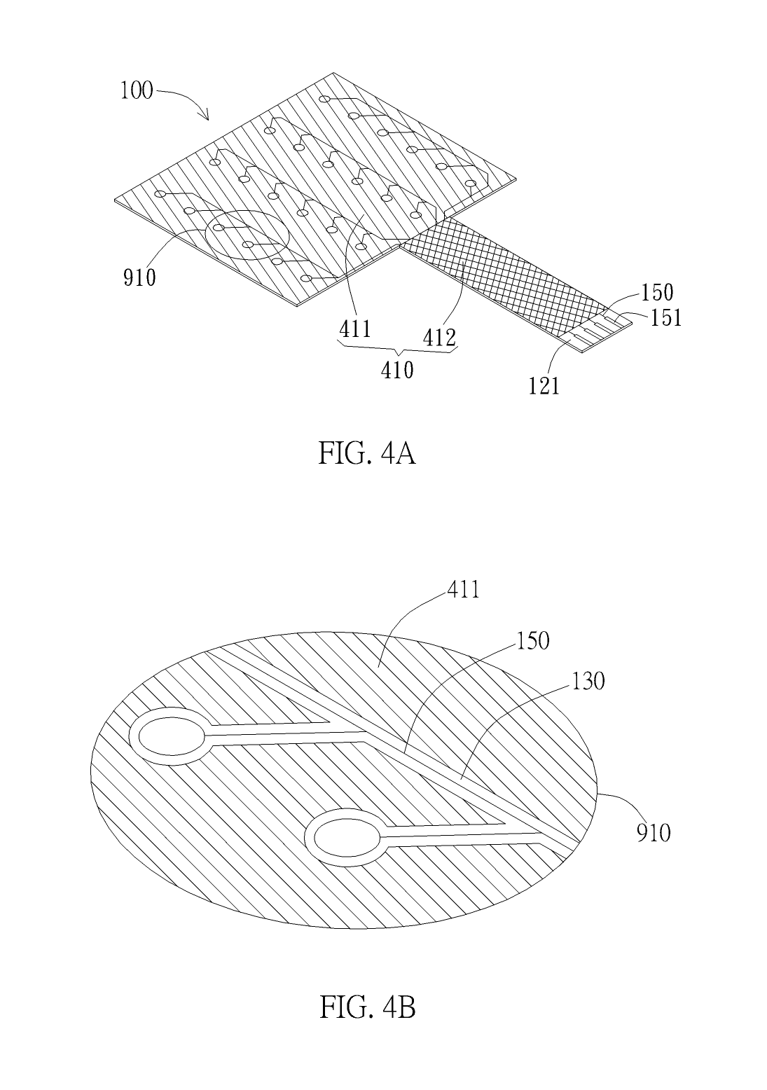

As shown by FIGS. 4A and 4B, in the preferred embodiment, the membrane switch of the invention further includes a first protection layer 410, disposed on the first circuit surface 130 between adjacent portions of the first circuitry 150 and excluding the distal end 121 of the first tail section 120 away from the first substrate section 110, for reducing mist and dust sticking onto the first circuit surface 130. In other words, the first protection layer 410 is disposed on the first circuit surface 130 and exposes the first circuitry 150 and the first tail section distal end 121. The first protection layer 410 can be a coating layer (e.g. hydrogel), an adherence film or a mixture of both depending on the requirement for using and manufacturing. In the preferred embodiment, the first protection layer 410 includes a first coating layer 411 and a first adherence film 412. The first coating layer 411 is disposed on the first circuit surface 130 between adjacent portions of the first circuitry 150. The first adherence film 412 is disposed on the first circuit surface 130 excluding the distal end 121 of the first tail section 120 away from the first substrate section 110. However, in different embodiments, for saving material cost of the coating layer, the first coating layer can be disposed only on circumferences of the joining lines of the first circuit surface 130 with the second circuit surface 230 and machining holes (not shown in the figures).

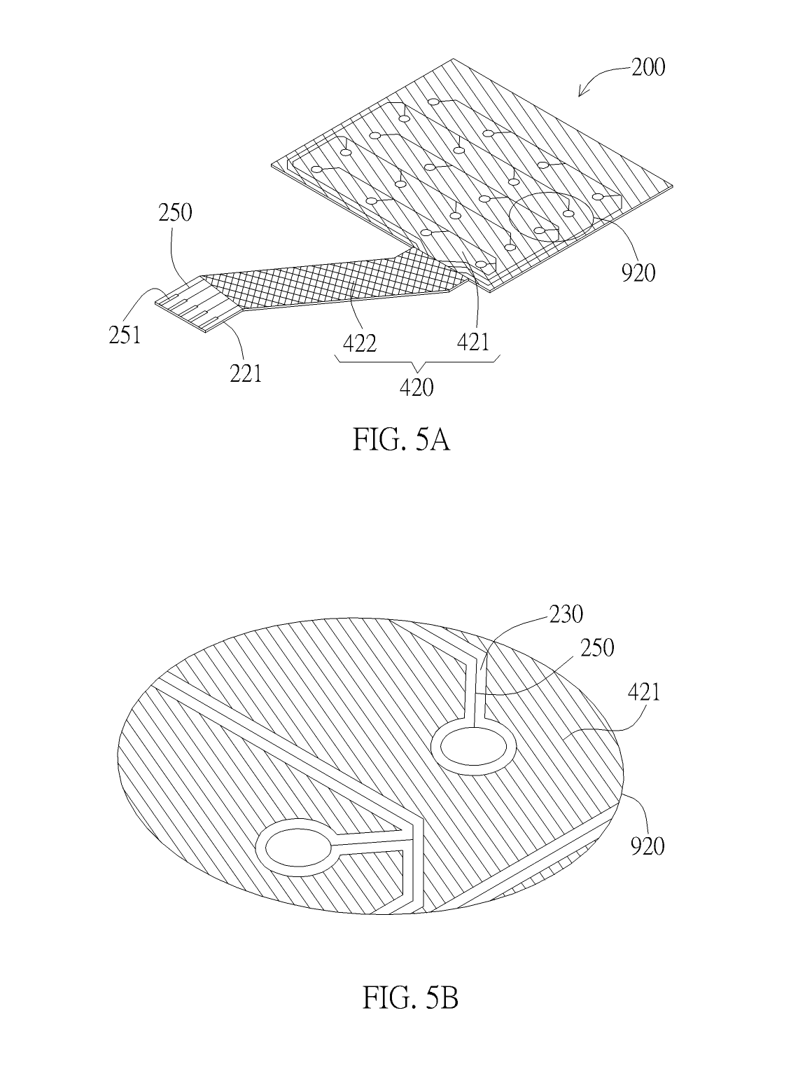

Similarly, as shown in FIGS. 5A and 5B, a second protection layer 420 is disposed on the second circuit surface 230 for reducing sticking of mist and dust. The second protection layer 420 is disposed on the second circuit surface 230 between adjacent portions of the second circuitry 250 and excluding the distal end 221 of the second tail section 220 away from the second substrate section 210. The second protection layer 420 is preferred to include a second coating layer 421 and a second adherence film 422. The second coating layer 421 is disposed on the second circuit surface 230 between adjacent portions of the second circuitry 250. The second adherence film 422 is disposed on the second circuit surface 230 excluding the distal end 221 of the second tail section 220 away from the second substrate section 221. In different embodiments, the second coating layer can be disposed only on circumferences of the joining lines of the second circuit surface 230 with the first circuit surface 130 and machining holes (not shown in the figures).

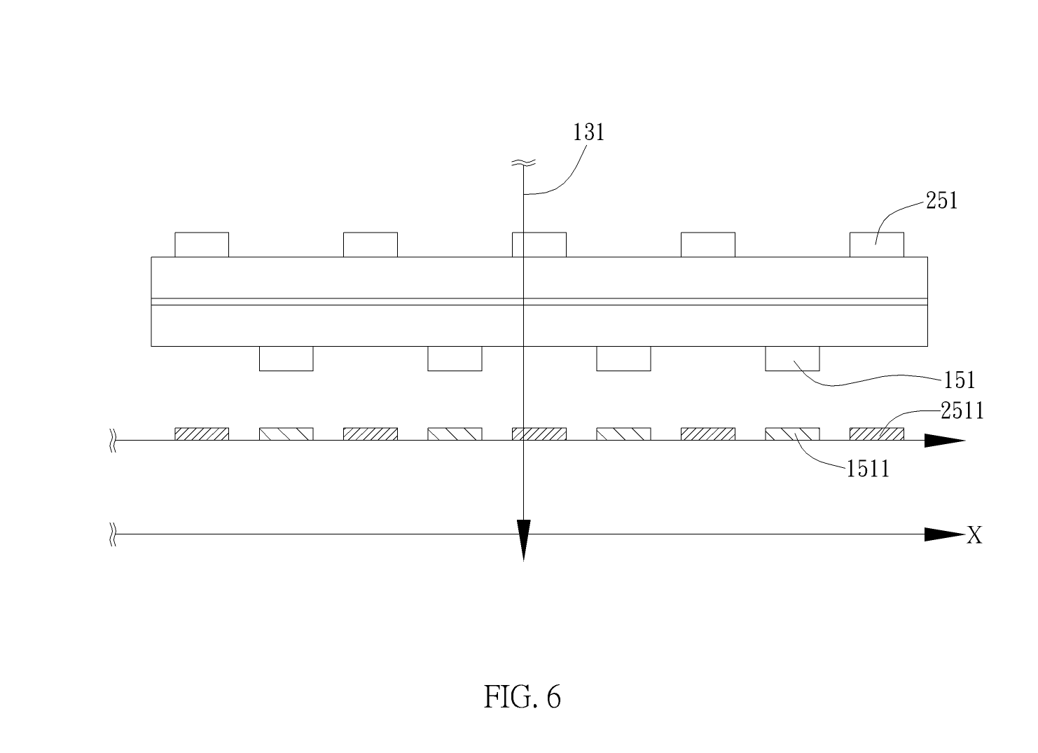

FIG. 6 is a sectional view along the section CC′ in FIG. 2, for illustrating the relational position of the first terminals 151 and the second terminals 251. In the preferred embodiment, projections 1511 and 2511 of each first terminal 151 and each second terminal 251 projected in the normal direction 131 of the first circuit surface 130 (referring to FIG. 2) are non-overlapped. Specifically, as shown by the preferred embodiment in FIG. 2, the first edge 160 and the second edge 260 are parallel to X axis. The projections 1511 and 2511 of the first terminals 151 and the second terminals 251 projected in the normal direction 131 of the first circuit surface 130 are non-overlapped in the X axis, as shown by FIG. 6. Therein, the non-overlapping of the first terminals 151 and the second terminals 251 is to arrange the projections 1511 of the first terminals 151 at even positions in the X axis and the projections 2511 of the second terminals 251 at odd positions in the X axis.

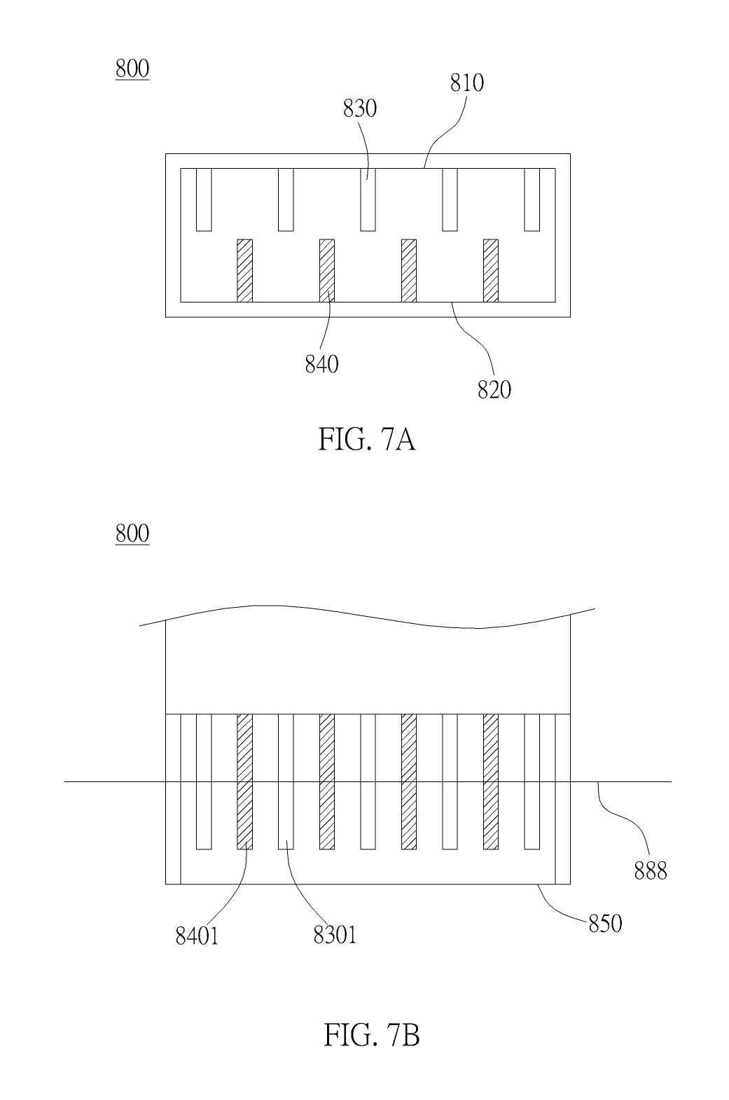

The non-overlapping disposition of the first terminals 151 and the second terminals 251 is conducive to avoidance of shorting a connection socket used for the invention. Specifically, as shown by the preferred embodiment in FIG. 7A, a connection socket 800 of the invention includes a first inner surface 810, a second inner surface 820, a plurality of first inner surface terminals 830, and a plurality of second inner surface terminals 840. The first inner surface 810 substantially extends on an X-Y plane (referring to FIG. 2). The second inner surface 820 is opposite to the first inner surface 810. The first inner surface terminals 830 are disposed on the first inner surface 810. The second inner surface terminals 840 are disposed on the second inner surface 820. As shown in FIG. 7B, projections 8301 of the first inner surface terminals 830 projected in a Z axis (referring to FIG. 2) and projections 8401 of the second inner surface terminals 840 projected in the Z axis do not overlap each other. In the preferred embodiment, the connection socket 800 further includes an opening edge 850. The first inner surface terminal projections 8301 and the second inner surface terminal projections 8401 are non-overlapped in a straight line 888. The opening edge is parallel to the straight line 888.

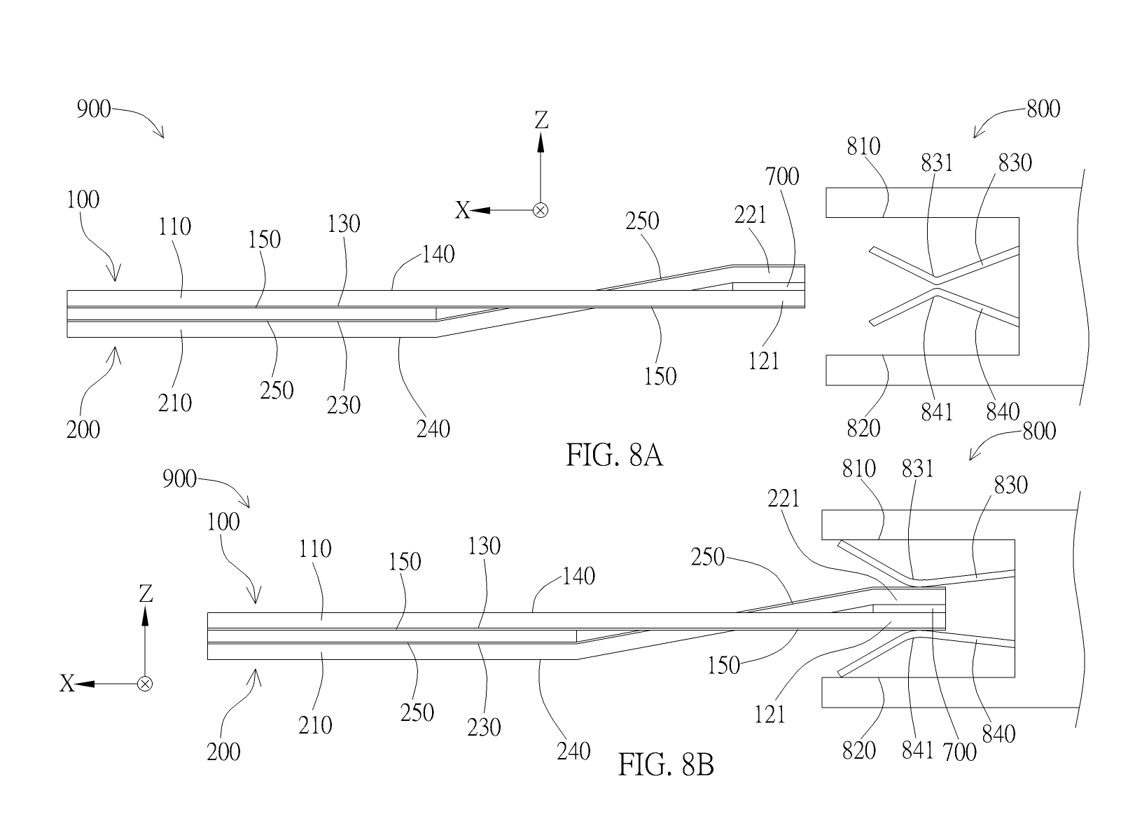

As shown by FIGS. 8A and 8B, a membrane switch 900 is inserted into and extracted out from the connection socket 800. In practice, the thickness of the connection port (i.e. the overlapped portions of the first tail section distal end 121 and the second tail section distal end 221) of the membrane switch 900 is usually larger than 0.15 mm. In other words, the distance between a contact portion 831 of the first inner surface terminals 830 for contacting the first terminals 151 for being electrically connected and a contact portion 841 of the second inner surface terminals 840 for contacting the second terminals 251 for being electrically connected is quite small. The first inner surface terminals 830 and the second inner surface terminals 840 may interlace in the Z axis due to a deliberate intention or use deformation as shown by FIG. 8A. At the moment, the first inner surface terminals 830 and the second inner surface terminals 840 of the connection socket 800 of the invention correspond to the first terminals 151 and the second terminals 251, interlacing in projection, respectively, such that the projections 8301 of the first inner surface terminals 830 and the projections 8401 of the second inner surface terminals 840 do not overlap each other. That is, even though the first inner surface terminals 830 and the second inner surface terminals 840 are non-overlapped in the Z axis as shown by FIG. 8A, the first inner surface terminals 830 and the second inner surface terminals 840 will not contact each other substantially, so as to reduce a possibility of shorting. In another aspect, in the preferred embodiment, the first tail section distal end 121 and the second tail section distal end 221 are joined together by an adhesive 700 for enhancing the joining strength.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A membrane switch, comprising:
a first membrane having a first circuit surface and a first back surface opposite to the first circuit surface, the first membrane comprising:
a first substrate section; and
a first tail section extending from the first substrate section, the first tail section comprising a first distal end; and
a second membrane having a second circuit surface and a second back surface opposite to the second circuit surface, the second membrane comprising:
a second substrate section; and
a second tail section extending from the second substrate section, the second tail section having a bypass portion and a second distal end;
wherein the first substrate section and the second substrate section overlap with the first circuit surface facing the second circuit surface;
wherein the bypass portion and the first tail section are non-overlapped so that the bypass portion is able to pass through a plane where the first tail section is located;
wherein the first distal end and the second distal end overlap with the first back surface facing the second back surface.

2. The membrane switch of claim 1, wherein the first membrane further comprises first circuitry disposed on the first circuit surface and extending from the first substrate section to the first tail section, the first circuitry comprises a plurality of first terminals disposed on the first distal end, the second membrane further comprises second circuitry disposed on the second circuit surface and extending from the second substrate section to the second tail section, and the second circuit comprises a plurality of second terminals disposed on the second distal end.

3. The membrane switch of claim 1, wherein the first tail section further comprising a first root portion where the first tail section is connected to the first substrate section, the second tail section further comprising a second root portion where the second tail section is connected to the second substrate section, and the first root portion and the second root portion are non-overlapped.

4. The membrane switch of claim 2, wherein projections of the first terminals and the second terminals projected in a normal direction of the first circuit surface are non-overlapped.

5. The membrane switch of claim 2, further comprising a first protection layer, covering the first circuit surface excluding portions of the first circuitry and the first distal end, so that the first circuitry and the first terminals are exposed.

6. The membrane switch of claim 5, wherein the first protection layer comprises a first coating layer, disposed on the first substrate section excluding portions of the first circuitry, and a first adherence film, disposed on the first tail section excluding the first distal end.

7. The membrane switch of claim 2, further comprising a second protection layer, covering the second circuit surface excluding portions of the second circuitry and the second distal end, so that the second circuitry and the second terminals are exposed.

8. The membrane switch of claim 7, wherein the second protection layer comprises a second coating layer, disposed on the second substrate section excluding portions of the second circuitry, and a second adherence film, disposed on the second tail section excluding the second distal end.

9. A connection socket, comprising:
a first inner surface substantially extending on an X-Y plane;
a second inner surface opposite to the first inner surface;
a plurality of first inner surface terminals disposed on the first inner surface; and
a plurality of second inner surface terminals disposed on the second inner surface, projections of the first inner surface terminals projected in a Z axis direction and projections of the second inner surface terminals projected in the Z axis direction not overlapping each other, the Z axis direction being substantially perpendicular to the X-Y plane.

10. The connection socket of claim 9, further comprising an opening edge, wherein the projections of the first inner surface terminals and the projections of the second inner surface terminals are non-overlapped in a straight line, and the opening edge is parallel to the straight line.

11. A membrane switch, comprising:
a first membrane having a first circuit surface and a first back surface opposite to the first circuit surface, the first membrane comprising:
a first substrate section;
a first tail section extending from a side of the first substrate section and having a first tail section distal end away from the first substrate section; and
first circuitry disposed on the first circuit surface and comprising a plurality of first switches and a plurality of first terminals, the first switches being disposed on the first substrate section, the first terminals being disposed on the first tail section distal end, the first terminals being arranged at a first edge; and
a second membrane having a second circuit surface and a second back surface opposite to the second circuit surface, the second membrane comprising:
a second substrate section;
a second tail section extending from a side of the second substrate section and having a second tail section distal end away from the second substrate section; and
second circuitry disposed on the second circuit surface and comprising a plurality of second switches and a plurality of second terminals, the second switches being disposed on the second substrate section, the second terminals being disposed on the second tail section distal end, the second terminals being arranged at a second edge;
wherein the first substrate section and the second substrate section overlap with the first circuit surface facing the second circuit surface, and when a user presses one of the first switches, the pressed first switch contacts one of the second switches for being electrically connected;
wherein the second tail section has a bypass portion passing through a plane where the first circuit surface is located, two projections of the bypass portion and the first tail section projected in a normal direction of the first circuit surface are non-overlapped, such that the two distal ends of the first tail section and the second tail section away from the first substrate section and the second substrate section respectively overlap with the first back surface facing the second back surface, and the first terminals and the second terminals are exposed out;
wherein the first edge and the second edge are parallel to a direction axis, and projections of the first terminals and the second terminals projected in the normal direction of the first circuit surface are non-overlapped in the direction axis.

12. The membrane switch of claim 11, wherein a width of the first tail section distal end is W1, a width of the second tail section distal end is W2, a width of the first tail section distal end and the second tail section distal end after overlapping each other is W3, and W3<(W1+W2).

13. The membrane switch of claim 11, wherein a width of the first tail section distal end is W1, a width of the second tail section distal end is W2, a width of the first tail section distal end and the second tail section distal end after overlapping each other is W3, and W3 is equal to the larger one of W1 and W2.

14. The membrane switch of claim 11, wherein the non-overlapping of the first terminals and the second terminals is to arrange the projections of the first terminals at even positions in the direction axis and the projections of the second terminals at odd positions in the direction axis.

15. The membrane switch of claim 11, wherein the second tail section is curved so that two projections of the bypass portion and the first tail section projected in the normal direction of the first circuit surface are non-overlapped.

16. The membrane switch of claim 11, wherein two projections of a root of the first tail section and a root of the second tail section projected in the normal direction of the first circuit surface are non-overlapped.

17. The membrane switch of claim 11, further comprising a first protection layer, disposed on the first circuit surface between adjacent portions of the first circuitry and excluding the first tail section distal end away from the first substrate section.

18. The membrane switch of claim 17, wherein the first protection layer comprises a first coating layer, disposed on the first circuit surface between adjacent portions of the first circuitry, and a first adherence film, disposed on the first circuit surface excluding the first tail section distal end away from the first substrate section.

19. The membrane switch of claim 11, further comprising a second protection layer, disposed on the second circuit surface between adjacent portions of the second circuitry and excluding the second tail section distal end away from the second substrate section.

20. The membrane switch of claim 19, wherein the second protection layer comprises a second coating layer, disposed on the second circuit surface between adjacent portions of the second circuitry, and a second adherence film, disposed on the second circuit surface excluding the second tail section distal end away from the second substrate section.
